(19) United States
(12) Patent Application Publication
(10) Pub. No.: US 2021/0233064 A1
(43) Pub. Date: Jul. 29, 2021

(54) SECURE TRANSACTIONAL SYSTEM IN A P2P ARCHITECTURE

(71) Applicant: Enrico MAIM, Feusisberg (CH)

(72) Inventor: Enrico MAIM, Feusisberg (CH)

(21) Appl. No.: 15/734,490

(22) PCT Filed: Jun. 6, 2019
(86) PCT No.: PCT/IB2019/054736

§ 371 Date: Dec. 2, 2020

Related U.S. Application Data
(60) Provisional application No. 62/681,187, filed on Jun. 6, 2018.

(51) Int. Cl. G06Q 20/36; G06Q 20/40; H04L 9/32; H04L 9/06

(52) U.S. Cl. CPC G06Q 20/36; G06Q 20/401; H04L 2209/38; H04L 9/0643; H04L 9/3221

(57) ABSTRACT

The invention relates to a secure P2P transactional system comprising a set of nodes (WN) communicating by messages (WM), each message comprising data to be processed by a program (WP) and the hash of the program to be used at the destination node on the input data contained in this message, wherein, upon receiving a message and by using the hash contained in this message, each node is capable of causing the execution of the program to be used on the input data contained in said received message, said program generating an output message containing output data generated by the program and the hash of the program. The system is characterized in that at least certain programs are capable of being executed in a zero-knowledge proof mode (ZKP) and of including in output messages a zero-knowledge proof information for verification by the destination node.

### FIELD OF THE INVENTION

The present invention relates, in a general manner, to secure transactional systems having a P2P node architecture.

### PRIOR ART

The patent applications WO2016120826A2 and WO2017122187A2, in the name of the applicant and incorporated herein by reference, describe the “wallet node” (or “WN”) model, a software+hardware model that aims to eliminate the need for trusted third parties within the context of contractual engagements (smart contracts) or transactions (such as Bitcoin transactions), while guaranteeing good execution of “executable contracts” (referred to as “wallet programs” or “WP”).

More precisely, the wallet nodes represent both:
a model of nodes (nodes of a network) which transmit or receive messages (“wallet message,” or “WM”), each WM comprising the hash of the program (#WP) which has allowed it to be generated, the WP program being intended to run on the destination node in order, in turn, to generate WMs which themselves include the hash #WP, and so on,
and a hardware model which guarantees it (without alteration).

The above-mentioned application WO2016120826A2 gives the example, with reference to FIG. 7 in this filing, of a message WM, representing a pairing of 10 units of account (units such as Bitcoins), transmitted by a node WN1 and destined for a node WN2, said message comprising the hash #WP of the program WP which has generated it, the destination thereof having to execute the same WP upon receiving the message.

According to the WP program of this example:
during the generation of the WM by WN1, exactly 10 units of account are removed from the persistent variable “balance” managed by WN1, and,
in response to WN2 receiving the WM, exactly 10 units of account are added to the persistent variable “balance” managed by WN2.

The combination of the model in the software (model according to which the WMs comprise the hash of the WP), and in the hardware (model according to which the destination WNs of the transmitted WMs necessarily execute the respective WPs specified therein) makes it possible to ensure that the respective balances are kept correct, and that, therefore, the units of account transferred during a first payment will not be subsequently transferred again (no double spend).

The above-mentioned application WO2016120826A2 also gives a “p2pinsurance” example of payments that are conditional on events (with reference to FIG. 8 of that filing), thus showing the generality of the model which is not limited to payments but makes it possible to implement all kinds of engagements (smart contracts).

Application WO2017122187A2 describes a “CMMU” (“Crypto Memory Management Unit”) component that implements the model of the WNs in the hardware (within a “wallet node device” or “SoC”). The principle of the CMMU is set out below.

The CMMU unit deals with the processing of the units of account (referred to as “tags” which may for example be Bitcoins) in a manner dissociated from the WPs, it thus being possible for the units of account to be transferred (from one WN to another) by different WPs; more precisely, the application WO2017122187A2 describes transfers of units of account stored in the form of Bitcoin transactions (UTXO model) which are thus independent of the WPs transferring them. Specifically, the application WO2017122187A2 describes, with reference to FIG. 4 of this application, that the tags are not persistent variables of a particular WP program executed in a WN, but units of account that can be used by the WN whatever the WP it executes. Units of account provided in the form of a tag, by a WP, thus belong to the WN, and can be used by another WP on the same WN. These are persistent variables for the WN taken as a whole. In the example shown in FIG. 4 of WO2017122187A2, the user of WN2 who receives a WM1 payment message, from a WN1 node, following a sale he has made to said WN1, executes a WP1 wallet program payment, and then pays an insurance premium by executing a WP2 insurance wallet program. Thus, 10 units of account are transferred from WN1 to WN2, by means of a WM1 message transmitted by executing WP1 (said message comprising the hash #WP1), and these 10 units of account are paid by WN2 in order to settle an insurance premium, by executing WP2 sending a WM2 message (comprising the hash #WP2) to a WN3 node.

The CMMU unit ensures that the tag units transferred will not be subsequently transferred again (no double spend). The WNs thus provide the same advantage as Bitcoin (which was invented precisely to resolve the double spend problem), but in this case without the need for a blockchain and without intervention of miners, with the further advantage of executable contracts (smart contracts). The WNs thus offer a performance equivalent to that of Ethereum, but without blockchain and without intervention of miners or validators.

It will also be noted that the CMMU unit includes a mechanism that makes it possible to force the use of tags by the WP programs. Thus, a tag can be reserved for use by a WP or by linked WPs (cf. FIG. 7 of WO2017122187A2) so as to prevent the units of account of the tag being able to be used by a WP which is not authorized to do so. Thus, a WP is capable of indicating to the CMMU that a tag is reserved for its use, and the CMMU allocates said tag a marking indicating this reservation, in the memory (MEMORY). This marking can be removed on the initiative of the same program, thus making the tag usable again by other WPs. In the event of an attempt, by a WP, to generate a transaction supplied by a tag for which said WP is not authorized, the CMMU prohibits the operation, and the units of account of this tag thus cannot be used (since a transaction of this kind cannot take place). This architecture allows the WNs to reserve units of account realized by tags for particular types of operations intended to be executed by the WPs which have, respectively, reserved them, and thus to implement engagements on the basis of the units of account which are blocked for this purpose, such as in the example “p2pinsurance” of payments conditional on above-mentioned events.

Furthermore, succinct zero-knowledge proof (ZKP) generation/verification techniques are known for execution of programs, such as provided in particular by the system Aurora https://eprint.iacr.org/2018/828.pdf and the software library “libiop” https://github.com/scipr-lab/libiop (incorporated herein by reference), or for millions of calculation elements. The generation takes a few minutes, the size of the proof is of the order of a few tens of kilo-octets, and its verification takes just a few seconds; more precisely, the size of the proof increases in a polylogarithmic manner, and its verification increases in a linear manner. Reference is made, in the following, to execution of programs with proof generation/verification having private/public inputs, by the term “ZN-SNARK execution” or even “in zero-knowledge proof mode” (whatever the method used, and without this being limiting).

### SUMMARY OF THE INVENTION

The present invention aims the possibility for the WPs o be executed not in the specialist hardware of the WN, as described in the applications cited above, but on conventional data processing equipment.

For this purpose, a secure transactional system in P2P is proposed, comprising a set of nodes (WN) communicating by messages (WM), each message comprising data to be processed by a program (WP) and the hash of the program to be used at the destination node on the input data contained in this message, each node being capable, upon receiving a message and by using the hash contained in this message, of causing the execution of the program to be used on the input data contained in said received message, said program generating an output message containing output data generated by the program and the hash of the program, said system being characterized in that at least certain programs are capable of being executed in a zero-knowledge proof mode (ZKP) and of including in output messages a zero-knowledge proof information for verification by the destination node.

In one embodiment, at least some nodes comprise a crypto memory management unit (CMMU) capable of receiving the messages and of delegating the execution to a non-secure processor, said processor being capable of executing the program while generating a zero-knowledge proof, and the CMMU unit being capable of receiving the zero-knowledge proof from said non-secure processor, of verifying said proof, and of including same in a transmitted message further containing the data (data2) generated by the non-secure processor.

In this case, the non-secure processor may optionally be capable of generating said proof, taking, as a private input, at least the input data, and as a public input at least the generated data, the CMMU unit being capable of verifying said proof by taking as public input at least the generated data.

In another embodiment, each node is capable of executing the programs in a manner non-secured per se, and each received message (WM1) contains a zero-knowledge proof (ZKP1) due to the fact that the data (data1) contained in said message were generated by a program corresponding to the hash (#WP) contained in said received message, while every program intended to process a message of this kind comprises a sub-program for verifying the proof contained in the received message, a sub-program for processing the data (data1) contained in the received message for generating the processed data (data2), and a sub-program for generating a zero-knowledge proof (ZKP2) for the execution of the program actually corresponding to the hash, and generating the processed data (data2).

Advantageously, said sub-program for generating a zero-knowledge proof receives, as a public input, the data generated by the processing sub-program.

According to another advantageous aspect, the system further comprises a mirror node mechanism that is capable of replicating the processings by one same program on a given message in a plurality of nodes that form mirrors, and of verifying the consistency of the output messages generated by these replicated processings.

In one application, the programs designated by their hash comprise transaction instructions on value units.

In the present invention, the mode of the WNs in the software is the same as that of the applications WO2016120826A2 and WO2017122187A2, except that the WM can now comprise the ZKP proof of the execution producing it, the same examples given being able to illustrate the embodiments which will now be described.

### BRIEF DESCRIPTION OF THE DRAWINGS

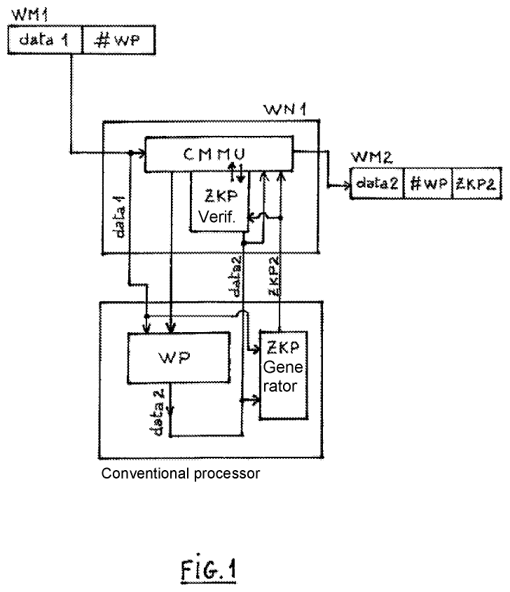

Other aspects, aims and advantages of the present invention will become clear upon reading the following detailed description of preferred embodiments of said invention, given by way of non-limiting example and with reference to the accompanying drawings, in which FIGS. 1 to 3 are functional block diagrams illustrating three embodiments of the invention.

### DETAILED DESCRIPTION OF PREFERRED EMBODIMENTS

### First Embodiment

In a first embodiment, a CMMU unit manages the data (the persistent variables) characteristic of the WNs, and the above-mentioned tags, as already described in the application WO2017122187A2, but delegates the execution of the WP in question to one or more conventional processors (which may be external to the WN device) which (by execution in ZK-SNARK) generate the ZKP proof of the results produced by this execution, including the proof of the authenticity and the integrity of the WP thus executed (proof which is verified by the CMMU), and advantageously allow the following WN (the WN receiving this result in a WM) to verify this ZKP proof.

More precisely, and with reference to FIG. 1, after a wallet node WN1 has received a WM1 input message comprising “data1” content (as well as the hash #WP, as before), its CMMU launches the execution of the WP program, in ZN-SNARK, on a conventional processor,
producing, if appropriate, one (or more) output WM2 message(s) comprising (respective) “data2” content(s) (produced as a result of this execution), and
generating the ZKP2 proof of the data2 result(s) and the authenticity of the WP—i.e. ensuring that the WP is indeed the program of which the hash #WP is that specified in the input WM1 (and of course its integrity, i.e. ensuring that the WP has not been altered), with data1 as private input and data2 as public input,
the CMMU verifies said ZKP2 proof by taking data2 as public input (and
advantageously, (each) WM2 includes said ZKP2 proof, and the destination of (each) WM2 (a WN which can itself launch said WP program on a conventional processor for execution in ZK-SNARK) first verifies said proof by means of data2 also taken as public input.

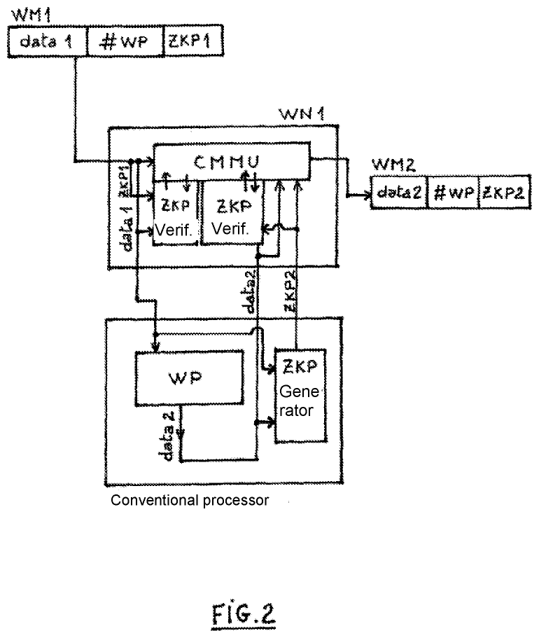

With reference now to FIG. 2, in the case where the WM1 message was produced by a wallet node of the same type, it comprises, itself, the ZKP1 proof of the data1 execution result and, upon reception of WM1, WN1 first verifies this ZKP1 proof received, the public input for said verification being data1.

For the record, the application WO2017122187A2 describes the format of the messages WM (triggering the launching of programs designated P1, P2, etc., their hashes being designated #P1, #P2, etc.) as follows:
a complete message format comprises an argument #spec containing the hash of a specification of constraints connecting #P1 and #P2, i.e. restricting the set of valid #P2s following a #P1:
   nonce1, §_{K2}(data+#P1+#P2), #spec, nonce2, K1, Sign_{K1}(nonce1, §_{K2}(data+#P1+#P2), spec, nonce2), sign_{K}(K1)

In one embodiment, this specification (“spec”) may be all the valid executable codes (#P1, #P2, etc.). In another embodiment, with reference to FIG. 11 of the application WO2017122187A2, for each executable code of which the hash is given (#P1), in this specification the set of the hashes of the valid executable codes (#P2, etc.) is given.

In the case where, for a given message, it is required that the (entirety of the) executable code which has to be executed by the recipient of the message should be the same as that executed by the transmitter of the message, i.e. the same #P is propagated from a received incoming message to a (or to each) generated output message, it is preferable for the format of the messages to be as follows, and for this particular unified format option to be used in the following, without this being limiting:

nonce1, § K₂data+#P, nonce2, K1, Sign_{K1}(nonce1, §_{K2}data+#P, nonce2), sign_{K}(K1)

The WMs of the present invention may furthermore include the ZKP proofs as follows:

nonce1, §_{K2}data+#P+ZKP, nonce2, K1, Sign_{K1}(nonce1, §_{K2}data+#P+ZKP, nonce2), sign_{K}(K1)

Again for the record, the application WO2017122187A2 describes that a device WN (SoC) comprises a CMMU unit (Crypto Memory Management Unit) which stores, or which is capable of dynamically regenerating (by PUF technology, cited above), the secret key of the WN (which is accessible only by the CMMU unit, which never reveals it), and said CMMU unit performs the following:
encryption of the program prior to storage,
allocation of space in the memory (addr1 . . . addr2 range) for storing the program thus encrypted, said allocated space thus making it possible to store persistent variables associated with this program, and ensuring the isolation of the programs from one another,
generation of the hash of the program, and
decryption for on-the-fly execution by at least one processor unit contained in the SoC,
the other processing steps described later in the present description.

FIG. 21 of the application WO2017122187A2 schematically shows the steps of the CMMU receiving a message containing a program to be loaded into the memory (MEMORY). It should be noted that the memory (MEMORY) may be external to the SoC, or not, and that it comprises a space reserved for the tags described above. The numbered steps represent the following steps:

1) receiving a message containing a program to be loaded into the memory,
2) since the program to be loaded is encrypted, and since the hash of the program before encryption has been determined, reserving a space in the memory that can contain said encrypted program and the persistent variables thereof, said hash subsequently making it possible to find it via a table (PHT).

Advantageously, the CMMU unit performs said storage of the encrypted program, instruction block by instruction block, and provides (to said processor) one single decrypted instruction block at a time (for the processor to execute the instructions that the block contains). Thus, the method for loading the programs (executable codes) in the SoC advantageously comprises the following steps. Upon the SoC receiving a message comprising P and #PP (in encrypted form § K2P+#PP . . . ), PP being the loading program of the program, and P being the content of the executable code to be loaded, the CMMU unit:

1. decrypts § K2P . . . and calculates the hash of the program to be loaded (#P);
2. creates a symmetrical key (PK) derived from {#P+the secret key of the SoC};
3. encrypts the instruction blocks of this executable code using said symmetrical key (§ PKPi);
4. allocates storage space (addr1 . . . addr2) in the memory for said blocks § PKPi, as well as for the future persistent variables manipulated by said program, and saves there the blocks § PKPi;
5. inserts information comprising #P, addr1, addr2 into a PHT table (Program Hash Table).

When a message, comprising input data for a certain program to be executed (P) and the hash (#P) of said program, is received by the SoC, its CMMU unit:

1. accesses, from the hash of the program #P received in the message, and via the PHT table, encrypted program blocks to be executed § PKP, stored in the memory in the space reserved therefor (addr1 . . . addr2);
2. decrypts, on-the-fly, the P instruction blocks, and transmits them to the processor unit;
3. the processor unit executes, on-the-fly, the decrypted instructions on the input data, the persistent variables linked to P being stored in isolation in addr1 . . . addr2, and the generated messages including #P and being signed by the CMMU.

Thus, prior to a message being transmitted by the SoC, the CMMU unit inserts, into the message to be transmitted, the hash (#P) of the program being executed, as well as the signature of said hash by the CMMU by means of the secret key (or inserts said hash of the program into the body of the message to be transmitted, which it signs with the secret key), which makes it possible, in the case where #P=#P1=#P2 (or, according to the description above, with reference to FIG. 7 of the application WO2017122187A2, in the case where the programs are grouped according to a specification) and if the destination entity also guarantees the execution integrity thereof, to use such programs as executable engagements (smart contract).

FIG. 22 of the application WO2017122187A2 schematically shows the interactions representing said steps between the different parts (PROCESSOR, CMMU, MEMORY) of the system:

1) reception, by the CMMU, of a message containing input data of a program to be executed, as well as the hash of said program;
2) the CMMU locates, in the PHT table and from said hash, said encrypted program, loads it into its memory, and decrypts it (block by block);
3) the CMMU transmits, on-the-fly, (one block at a time of) the decrypted program to the PROCESSOR for execution;
4) if necessary, the PROCESSOR requires access to persistent variables (PSV and/or tags) already created or being created/updates them and requests to store them, or suppresses them, and
5) the CMMU accesses and decrypts/encrypts and stores said persistent variables;
6) if necessary, the PROCESSOR prepares a message to be transmitted, and
7) the CMMU inserts therein the hash of said program being executed, and the signature thereof, by means of the secret key, and transmits the message.

The CMMU is advantageously capable of verifying the required intersections of sets of mirror nodes, described above in the application WO2017122187A2, upon reception of a WM, and for each tag transfer transaction received.

With reference to FIG. 22 of the application WO2017122187A2, the WMs can be transmitted by a SoC (i.e. generated by the execution of a program WP) or received as input from the user or by another device (“Quasi-WM” messages), and comprise the hash #WP of this program in both cases.

FIG. 23 of the application WO2017122187A2 shows an input tag transfer message WM which conveys a transaction (tx1), said transaction bringing about in the memory (MEMORY), in the region of the tags, the insertion of the tags brought by said new transaction, each tag comprising the data representative of the succession (graph) of the transactions upstream, as already described, the address of the upstream WN that generated it, and the addresses of its mirror WNs, being associated with each transaction. Using this information, in order to validate, or not validate, the message, the CMMU verifies the intersection required between its own mirror nodes and said WN mirror addresses, as well as the fact that at least one (or some, depending on the configuration parameters) is/are hard WNs. This figure also shows an output tag transfer message WM which brings about a transaction (tx2) generated by the CMMU upon instruction of a WP, the CMMU neutralizing (rendering unusable again) the tags used by said generated transaction (to avoid a double-spend), and generating the new tag or tags which are output, respective graphs of the upstream transactions being associated therewith (from the graphs upstream thereof).

Furthermore, the CMMU manages the transaction simplifications (described in the application WO2017122187A2 in the section “Off-chain Bitcoin Transactions”). A simplification of this kind consists in replacing at least two earlier inter-WN transactions which are not yet inserted into the blockchain, with a new (or the fewest possible) replacement transaction(s), the CMMU ensuring that the current balance remains unchanged by these replacements (this mechanism is generic, the tag transfer transactions being more general than the Bitcoin transactions).

FIG. 23 of the application WO2017122187A2 also shows an https request generated by the CMMU unit, which deals with the handshakes and the cryptographic operations, leaving the role of input/output interface (in the region of the TCP) to the terminal to which it is coupled, in order to ensure the integrity of the data from start to finish (the accessed site being trusted).

Finally, the CMMU unit also deals with the management and the signature, by the SoC, of non-WM messages (at the output, as shown in FIG. 23 of the application WO2017122187A2 and described above in the section “WN transmitting a message to the outside world”).

In a manner different from the invention described in the application WO2017122187A2, according to the present invention the execution (in ZK-SNARK) of the WP can be performed in a conventional processor which may be outside of the SoC. Thus, with reference to FIG. 22 of the application WO2017122187A2, in this case the term PROCESSOR denotes a conventional processor of this kind, and step 3 is replaced by “CMMU transmits the decrypted program to the PROCESSOR for execution in ZK-SNARK,” while step 5 is followed by the steps of “PROCESSOR transmits the proof ZKP and its execution to CMMU,” and “CMMU verifies the received proof ZKP.”

Apart from the differences/additions set out hitherto, the entirety of the content of the application WO2017122187A2 remains applicable.

In this first embodiment, the CMMU can be replaced by an SGX enclave (by Intel) or similar, which is capable of managing the persistent variables of the WNs in a secure manner.

### Second Embodiment

In a second embodiment, the identities of the WNs are Bitcoin addresses (or the like), the WNs are purely software (the CMMU is not necessary), and any payment is inserted into the Bitcoin blockchain (or similar). This embodiment implies that the signatures by a WN are performed by means of the Bitcoin private key corresponding to the address of the WN. In this case, the units of account (“tags”) mentioned above are Bitcoins (or similar). The advantage offered by the WNs in this case is that it is not necessary to restrict oneself to Bitcoin (which is limited to payments), but on the contrary all the generality of executable contracts (smart contracts) is available, the Bitcoin protocol (or similar) being used for the payments, and the authenticity/integrity of the executable contracts (smart contracts) being guaranteed by the WNs, and thus the performance of Ethereum is achieved on the Bitcoin protocol (or similar).

In this case, a WP is a program, executed in ZK-SNARK in a computer associated with a given WN (for a Bitcoin address), which is activated automatically upon reception of messages WM intended for said WN, the ZKP proof generated including the proof of the authenticity and integrity of the executed WP (with respect to the #WP transmitted in the input messages) to provide results (data2), it being possible for said proof to be included in the WM2 messages generated and verified by their destination WNs.

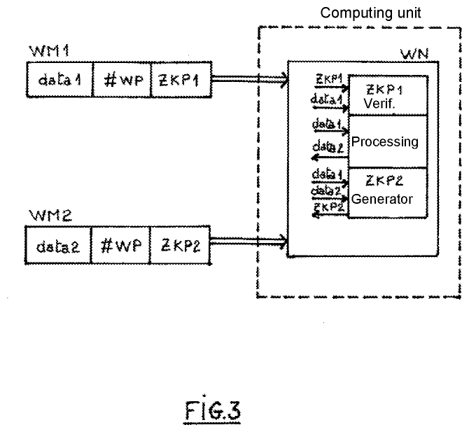

In other words, and now with reference to FIG. 3, each time a computer, associated with a given wallet node, receives a message (WM1) comprising the elements specified above (i.e. data1, #WP, and ZKP1), the WP corresponding to #WP in this computer
is executed in ZK-SNARK by first verifying the ZKP1 proof included in the received message, data1 being taken as public input, and
generates, if necessary, messages (WM2) which advantageously include the proof (ZKP2) of the authenticity and the integrity of the WP program executed, and the data2 content provided (data1 being, in this case, the private input, and data2 the public input).

More precisely, after the computer associated with a wallet node WN1 has received a WM1 input message comprising “data1” content and the hash #WP, the WP program corresponding to #WP is executed in ZN-SNARK on said computer for
producing, if appropriate, one (or more) output WM2 message(s) comprising (respective) “data2” content(s) (produced as a result of this execution), and
generating the proof (ZKP2) of said data2 result(s), data1 being the private input and data2 being the public input, and the authenticity of the WP, i.e. ensuring that the WP is indeed the program of which the hash #WP is that specified in the input WM (and of course its integrity, i.e. ensuring that the WP has not been altered),
it being possible for (each) WM2 to include said proof, and for the destination of (each) WM2 (which in this case is a WP program in ZN-SNARK on a conventional processor which is triggered at each message WM received for the destination WN) to verify ZKP2 by means of data2 taken as public input,
in the case, again, insofar as the WM1 was produced by a wallet node of the same type, it advantageously comprises, itself, the proof (ZKP1) of the data1 execution result and, upon reception of WM1, WN1 first verifies ZKP1, the public input for said verification being data1.

Of course, ZKP2 can be transmitted to the transmitter WN of WM1 (in the form of a WM2 message) and, since the Bitcoin payments can be made conditional (cf. https://en.bitcoin.it/wiki/Contract), the verification of ZKP2 can be a condition of the validity, if appropriate, of a Bitcoin transaction brought about by WM1.

Said second embodiment finds its meaning, to the full, when the WNs are rendered redundant by means of WN mirrors (described in the application WO2017122187A2), as will now be recalled below for the third embodiment. Indeed, the WN mirrors check and validate one another, thus ensuring good execution of the WPs specified in the incoming messages WM. The second embodiment described hitherto is understood, here, as being implemented with WN mirrors, as for the third embodiment (see below) but with private/public keys of the Bitcoin type.

### Third Embodiment

In a third embodiment, the owners of the WNs can create a pair of cryptographic keys (public/private keys),
the address of the WN can be derived from the public key of this pair, and
as for the second embodiment, a WP is a program, executed in ZK-SNARK in a computer associated with a given WN (at said address), which is activated automatically upon reception of messages WM intended for said WN, the ZKP proof generated including the proof of the authenticity and integrity of the executed WP (with respect to the #WP transmitted in the input messages) to provide results (data2), it being possible for said proof to be included in the WP2 messages generated and verified by their destination WNs.

Here, too, each time a computer, associated with a given wallet node, receives a message (WM1) comprising the elements specified above (i.e. data1, #WP, and ZKP1), the WP corresponding to #WP in this computer
is executed in ZK-SNARK by first verifying the ZKP1 proof included in the received message, data1 being taken as public input, and
generates, if necessary, messages (WM2) which advantageously include the proof (ZKP2) of the authenticity and the integrity of the WP program executed, and the data2 content provided.

More precisely, as in the case of the second embodiment, after the computer associated with a wallet node WN1 has received a WM1 input message comprising “data1” content and the hash #WP, the WP program corresponding to #WP is executed in ZN-SNARK on said computer for:
producing, if appropriate, one (or more) output WM2 message(s) comprising (respective) “data2” content(s) (produced as a result of this execution), and
generating the ZKP proof of said data2 result(s) and the authenticity of the WP, i.e. ensuring that the WP is indeed the program of which the hash #WP is that specified in the input WM (and of course its integrity, i.e. ensuring that the WP has not been altered),
it being possible for (each) WM2 to include said proof, and for the destination of (each) WM2 (which in this case is a WP program in ZN-SNARK on a conventional processor which is triggered at each message WM received for the destination WN) to verify said proof by means of data2 taken as public input, and
insofar as the WM1 was produced by a wallet node of the same type, it advantageously comprises, itself, the proof (ZKP1) of the data1 execution result and, upon reception of WM1, WN1 first verifies ZKP1, the public input for said verification being data1.

This embodiment is particularly well suited for local contractual engagements or local transactions, i.e. in a network of highly interconnected nodes, especially when at least some of the WNs of such a network are “hard WNs” (hardware-secured WN) within the meaning of applications WO2016120826A2 or WO2017122187A2, or indeed within the meaning of the first embodiment of the present invention (in the CMMU), as will be explained in the following.

The integrity and the authenticity of the WPs is ensured by the redundancy of execution provided by the WN mirrors described in the application WO2017122187A2.

For the record, this redundancy is created for each node with “mirror nodes,” in which the data are held in a synchronized manner, and some of which perform the processing in a mirrored manner, in order to, at the same time:
compensate for the “non-responsiveness,” and
mitigate the risk of violation (“tampering”).

In this embodiment (cf. WO2017122187A2), a “node” (wallet node) is a virtual node (denoted VWNx for “virtual wallet node” of the user x), realized by a plurality of mirror nodes, comprising:
a real node RWN (corresponding to said virtual node) and
a set of countersignature nodes CWN.

In this embodiment, two WNs can be linked by executable contracts (WP) executed on the respective nodes thereof only if:
they are each associated with a number, greater than a first given threshold, of common mirror nodes having “connection weights” (with respect to each of said two nodes) which are greater than a second threshold (thresholds determined according to the configuration parameters), and
in the case of two nodes interacting by execution of a WP, a WM sent from one to the other is valid only if at least 10% (or another percentage also determined according to the configuration parameters) of common mirror nodes have executed said contract identically (“in the mirror”) and have transmitted an identical WM to the other node.

The “connection weights” are described in detail in the application WO2017122187A2.

In other words, a destination node of a WM validates this message only if the respective sets of mirror nodes of the transmitting and destination nodes have an intersection, the number of elements of which is greater than a first given threshold, and if the destination node has received this same WM (redundantly) from at least a given fraction (corresponding to a second threshold) of said mirror nodes belonging to said intersection.

For example, the real WN of the Bob node will consider a message WM, sent by the real WN of the Alice node, to be valid only if it also receives said transmitted message (in the name of the Alice node) from at least 10% of their common mirror nodes.

Each node executing wallet programs synchronizes its data (i.e. the persistent variables of its wallet programs, as well as its tags, over all its mirror nodes, said nodes including joining all the respective mirror nodes in common with the nodes with which said each node has an active wallet program.

These data synchronizations are performed:
in part by sending WMs which trigger the update of the data (persistent variables of the WPs and tags) by the (same) WPs which are executed on the receiver nodes, and,
for the nodes which do not receive them, the data are synchronized directly by the data update notification WMs.

In the present invention, the mirror nodes also synchronize (and mutually validate) the ZKP proofs that they receive or generate.

Furthermore, each node synchronizes the list of its mirror nodes with the nodes with which it has a connection weight greater than a threshold, and said data synchronizations take place with respect to said lists of mirror nodes. The synchronization of the lists takes place by means of corresponding WMs.

FIG. 3a of application WO2017122187A2 illustrates the propagation of a WM from a given VWN1 to a destination VWN2.

The mirror nodes RWN1, CWN1 each store the list L2 of the mirror nodes of VWN2, in order to be able to route the WM having identical content for all the transmission mirror nodes and the destination mirror nodes.

FIG. 3b of the application WO2017122187A2 more precisely describes the sending of messages between mirror nodes. It shows two of the sets of countersignature nodes in common, CWN_{AB} between the Alice and Bob nodes, and CWN_{B}c between the Bob and Carl nodes, the joining of said two sets (+the real Bob node RWN_{B}) being all the mirror nodes of the Bob node which are synchronized following any message WM sent to the Bob node.

Thus, the Alice and Carl nodes each know not only their respective mirror nodes in common with the Bob node, but the entire set of mirror nodes of the Bob node (owing to the synchronization of the list of mirror nodes mentioned above).

FIG. 3b of the application WO2017122187A2 also shows a WM generated by the Alice node following an interaction with the user (Alice), which WM must be sent to the Bob node. Firstly, an announcement message (denoted PWM for “pre-wallet-message”) of the message WM is sent by the real Alice node RWN_{A} to the mirror Alice nodes CWN_{AB} in common with the Bob node (just one PWM being shown, in order not to complicate the figure), and the other Alice nodes CWN_{XA} receive a data synchronization message (denoted DSM for “data sync message”). Subsequently, the real Alice node RWN_{A}, as well as each of said countersignature nodes CWN_{AB} in common with the Bob node, send the message WM in question to the Bob node, i.e. to the real Bob node RWN_{B} and to the countersignature nodes of the Bob node (only some of said messages WM being shown, in order not to complicate the figure).

FIG. 3c of the application WO2017122187A2 shows a phase of attempting to synchronize the set of mirror Bob nodes (RWN_{B}, CWN_{AB}, CWN_{BC}) via messages of the DSM type, in a situation where the real node RWN_{B} is non-responsive for one reason or another.

Finally, FIG. 3d of the application WO2017122187A2 shows a WM′ message, sent by the node VWN_{B} to the Carl node VWN_{C}, which message is generated not following an interaction of the real Bob node with its user (Bob), but following said message WM received from the Alice node (generated by the executed WP instructions). In this case, the mirror nodes which have actually received said message from the Alice node are capable of generating said message at the Carl node (by execution of said WP). However, FIG. 3d shows that the real Bob node is non-responsive and thus does not transmit the WM′ message (which is represented by “!” in the figure), and that, despite this, the other mirror nodes of the Bob node send said message to the Carl node VWN_{C} (which solves the problem of non-responsiveness).

Finally, again, as the message WM′ is transmitted (by the Bob node) not following interaction with the user but by execution of a smart contract WP (on said Bob node) in response to a message WM (received from the Alice node), each of the mirror nodes VWN_{C} of which receive WM′ will require a message that is 10% identical (or another percentage determined according to the configuration parameters) to be received by mirror nodes CWN_{B}c in common with said (Bob) node. Carl can thus count on the fact that said message was indeed generated, and was indeed generated by the smart contract WP in question, which was not altered (the problem of guaranteeing engagements is thus resolved).

The application WO2017122187A2 describes, with reference to FIG. 6 thereof, a method for using mirror nodes to mitigate the risk of double-spending in a succession of tag transfer WMs, said method making it possible, in particular, to implement Bitcoin transactions off-chain (the use of the blockchain becoming optional). This figure shows a message denoted “WM_{CY/tgx},” sent by the Carl node to a Y node (only the countersignature nodes “CWN_{CY}” of which in common with the Carl node are in the figure). Said message WM_{CY/tgx} transmits a transaction, the predecessor transactions of which (in the tag succession chain “tgx”) being previously transmitted by the messages WM_{XA/tgx}, WM_{AB/tgx} and WM_{BC/tgx}. The aim of the figure is to show that the Carl node ensures that there is one, or a certain number of, common mirror node(s), one of which is (or some of which are) hard WN, having all the nodes upstream, here with the Alice node (this is indicated in the figure as: “CWN_{CY}=CWN_{XA}”).

For the record, a Bitcoin transaction amounts to transferring BTCs, by signing (with a private key) at least one output of a preceding transaction which allocates them to at least one new owner, whose Bitcoin address is derived from its public key. In this case, the situation is considered in which the secret private key of a WN is a private key corresponding to a Bitcoin address (i.e. the WN generates a Bitcoin address from its secret private key). The WN is thus capable of generating a Bitcoin transaction, the input (or one of the inputs) of which is connected to an output (which is intended therefor) of an upstream transaction (which, for example, the user of said WN has been able to access, since it is published in the blockchain, and has entered it into said WN as input in its terminal), and (optionally) of announcing it (broadcast) in order for it to be inserted into the blockchain. This is understood to mean that this is a real and well-formed Bitcoin transaction which is generated by said WN. Nonetheless, in the application WO2017122187A2 the section “Off-chain Bitcoin Transactions” explains the advantages of not inserting it therein.

The BTCs used by a WN can originate from a succession of off-chain transactions, forming a graph and transferring the BTCs from one or more nodes to one or more other nodes, and it is desirable to mitigate the risk of a double-spend on any of said nodes generating said transactions. This is achieved by the following supplementary condition (which is added to the conditions specified above relating to the mirror nodes of the transmission and destination nodes of a WM): In order for a WM transferring a given tag (for example 0.5 BTC) to be validated by its destination node, the set of mirror nodes of the destination node must have an intersection, the number of elements of which is greater than a given threshold, with the set of mirror nodes of each of the nodes of the upstream graph (of tag transfer transactions) from which said tag originates, and at least the one, or one of them (or some of them) must be hard WN. Implementing the execution of the process by a WN thus includes crossing, passing from downstream to upstream, the graph of the WMs bringing about the tag transfer transactions, and verifying said mirror node intersection condition.

Advantageously, each tag includes the information of the graph of the upstream tag transfer transactions, each indicating the address of the WN that generated it (these WNs are referred to as “upstream WN”), which makes it possible, at a destination WN of a tag transfer WM, to directly verify whether at least one mirror (or a particular number) of all the upstream nodes is in its circle, is part of its own mirror nodes, and is a hard WN, and, for each upstream WN which is not, in this case, whether the connection weight of one of its mirrors, which is a hard WN, allows it to be part thereof (following possible exchanges of new connections with nodes of its circle). Thus, more precisely, all the upstream tags are associated with each tag (i.e. tags appearing in the upstream graph, in all the chains of succession of transfer tag transactions leading to the tag in question), with the address of the owner node that generated it and, if required, with the address of each of its subsequent owners (OWN, cf. WO2016120826A2), as well as the addresses of their mirror nodes, which allows each destination node of a WM transmitting a tag transfer transaction to directly verify the required intersection between its own mirror nodes and said mirror node addresses of each of said owners, as well as the fact that at least one (or some, depending on the configuration parameters) are hard WNs, and, if required, a search for nodes having a high connection weight is launched, in order to join new mirror nodes.

The entirety of the text of the application WO2017122187A2 is applicable to the third embodiment of the present invention, apart from the differences/additions set out.

Since one same WN model is divided among them, in the software, WNs of the first, second and third embodiments of the present invention can send/receive WMs between one another, in a heterogeneous manner, in the same WN network. Even the WNs according to the applications WO2016120826A2 and WO2017122187A2 can send messages in a heterogeneous network of this kind, insofar as the proof ZKP of the integrity/authenticity of their execution is not to be verified (since the hardware guarantees it). Thus, the WNs according to the present invention do not have to verify the proof ZKP in the incoming WMs according to the applications WO2016120826A2 or WO2017122187A2, or, more generally, in the WMs where said proof ZKP is not provided.

Of course, the present invention is not limited to the embodiments described, but a person skilled in the art will be able to make numerous variations and amendments to it, in the light of his general knowledge in the art.

1. Secure transactional system in P2P, comprising a set of nodes (WN) communicating by messages (WM), each message comprising data to be processed by a program (WP) and the hash of the program to be used at the destination node on the input data contained in this message, each node being capable, upon receiving a message and by using the hash contained in this message, of causing the execution of the program to be used on the input data contained in said received message, said program generating an output message containing output data generated by the program and the hash of the program, said system being characterized in that at least certain programs are capable of being executed in a zero-knowledge proof mode (ZKP) and of including in output messages a zero-knowledge proof information for verification by the destination node.

2. System according to claim 1, wherein at least some nodes comprise a crypto memory management unit (CMMU) capable of receiving the messages and of delegating the execution to a non-secure processor, said processor being capable of executing the program while generating a zero-knowledge proof, and the CMMU unit being capable of receiving the zero-knowledge proof from said non-secure processor, of verifying said proof, and of including same in a transmitted message further containing the data (data2) generated by the non-secure processor.

3. System according to claim 2, wherein the non-secure processor is capable of generating said proof, taking, as a private input, at least the input data (data1), and as a public input at least the generated data (data2), the CMMU unit being capable of verifying said proof by taking as public input at least the generated data (data2).

4. System according to claim 1, wherein each node is capable of executing the programs in a manner non-secured per se, in which each received message (WM1) contains a zero-knowledge proof (ZKP1) due to the fact that the data (data1) contained in said message were generated by a program corresponding to the hash (#WP) contained in said received message, and wherein every program intended to process a message of this kind comprises a sub-program for verifying the proof contained in the received message, a sub-program for processing the data (data1) contained in the received message for generating the processed data (data2), and a sub-program for generating a zero-knowledge proof (ZKP2) for the execution of the program actually corresponding to the hash, and generating the processed data (data2).

5. System according to claim 4, wherein said sub-program for generating a zero-knowledge proof receives as public input the data (data2) generated by the processing sub-program.

6. System according to claim 4, further comprising a mirror node mechanism that is capable of replicating the processings by one same program on a given message in a plurality of nodes that form mirrors, and of verifying the consistency of the output messages generated by these replicated processings.

7. System according to claim 1, wherein the programs designated by their hash comprise transaction instructions on value units.

8. System according to claim 2, wherein the programs designated by their hash comprise transaction instructions on value units.

9. System according to claim 3, wherein the programs designated by their hash comprise transaction instructions on value units.

10. System according to claim 4, wherein the programs designated by their hash comprise transaction instructions on value units.

11. System according to claim 5, wherein the programs designated by their hash comprise transaction instructions on value units.

12. System according to claim 6, wherein the programs designated by their hash comprise transaction instructions on value units.

13. System according to claim 5, further comprising a mirror node mechanism that is capable of replicating the processings by one same program on a given message in a plurality of nodes that form mirrors, and of verifying the consistency of the output messages generated by these replicated processings.

14. System according to claim 13, wherein the programs designated by their hash comprise transaction instructions on value units.
